(19) United States
(12) Patent Application Publication
(10) Pub. No.: US 2007/0224104 A1
(43) Pub. Date: Sep. 27, 2007

(54) Method for the Preparation of Y-Branched Carbon Nanotubes

(76) Inventor: Young Nam Kim, Seoul (KR)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 10/587,625

(22) PCT Filed: Feb. 4, 2005
(86) PCT No.: PCT/KR05/00337

§ 371 Date: May 24, 2007

(30) Foreign Application Priority Data
Feb. 9, 2004 (KR) 10-2004-0008417

(51) Int. Cl. B82B 3/00

(52) U.S. Cl. 423/445 B; 977/742

(57) ABSTRACT

The present invention provides a process for preparing Y-branched carbon nanotubes and the product thereby, Y-branched carbon nanotubes. More specifically, the present invention provides a process for preparing Y-branched carbon nanotubes, comprising: loading a catalyst on a carbon nanotube carrier; pre-treating the catalyst-loaded carbon nanotubes to have the catalyst bonded tightly to the surface of carbon nanotubes; and performing a synthetic reaction of carbon nanotubes using the obtained catalyst-loaded carbon nanotubes. According to the process of the present invention, Y-branched carbon nanotubes having at least one or more Y-junctions in various shapes can be prepared easily, simply and in bulk by utilizing the conventional facilities under the usual condition of process. Thus, the invention is promising industrially. The Y-branched carbon nanotubes of the invention holds great potential in regard of materials for electrodes, reinforcing agents for polymers, transistors and electrochemical products.

### TECHNICAL FIELD AND BACKGROUND ART OF THE INVENTION

This invention relates to a process for preparing Y-branched carbon nanotubes and the product thereby, Y-branched carbon nanotubes. More specifically, the invention concerns Y-branched carbon nanotubes and a process for preparing Y-branched carbon nanotubes comprising the step of: loading a catalyst on a carbon nanotube carrier; pre-treating the catalyst-loaded carbon nanotubes to have the catalyst bonded tightly to the surface of carbon nanotubes; and performing a synthetic reaction of carbon nanotubes using the obtained catalyst-loaded carbon nanotubes.

Carbon nanotubes are substances shaped in cylindrical tubes consisting of carbon atoms, of which a carbon atom is bonded to adjacent three carbon atoms and the bonds between carbon atoms form hexagonal rings repeatedly on a plane in the shape of hives which is rolled up to give the cylindrical tube.

In the past ten years, the study on carbon nanotubes has been conducted with respect to the physical properties, the preparations and the applications on account of their excellent thermal, mechanical and electrical characteristics. With regard to the various kinds of synthetic methods of carbon nanotubes, arc discharge, laser ablation, thermal chemical vapor deposition (CVD), catalytic synthesis and plasma synthesis have been reported [see U.S. Pat. No. 5,424,054, Arc discharge; Chem. Phys. Lett. 243, 1-12(1955) Laser ablation; Science 273, 483-487 (1966) Laser ablation; U.S. Pat. No. 6,210,800, Catalytic synthesis method; U.S. Pat. No. 6,221,330, Gaseous synthesis method; WO 00/26138, Gaseous synthesis method].

However, these methods are to synthesize one dimensional carbon nanotubes in the shape of tube or rod and have limitations in synthesizing Y-branched carbon nanotubes with Y-junction structure. The terms of “one dimensional”, “two dimensional” and “three dimensional” stated in the present invention do not mean the spatial dimensions but have the following meaning. Namely, a “linear carbon nanotube having one dimensional structure” denotes a linear carbon nanotube which is not connected to other carbon nanotubes both at its start point and end point, an “Y-branched carbon nanotube with two dimensional structure” denotes a carbon nanotube which has merely one Y-junction, and a “Y-branched carbon nanotube having three dimensional structure” denotes a carbon nanotube in which branches grown from more than one Y-junctions on a linear carbon nanotube form a tree-like structure.

So far, various applicable fields of carbon nanotubes have been reported and each field requires specified carbon nanotubes for its practical application. For instance, when carbon nanotubes are used as materials for electrodes, reinforcing agents for polymers, transistor or electro-chemical products, the branched carbon nanotubes having two or three dimensional tree-like structure are much more preferable to the linear carbon nanotubes having one dimensional tube or wire-like structure.

On the other hand, the existence of such Y-branched carbon nanotubes was predicted just after the linear carbon nanotube was found by Dr. Iijima (S, Iijima, Nature 354, 1991, 56) in 1991 [see A. L. Mackay et al., Nature 352(1991) 762; G. E. Scuseria, Chem. Phys. Lett. 195(1992) 534]. Thereafter a lot of reports have been presented.

For instance, Dan Zhou et al. reported that the L, Y and T types of carbon nanotubes can be produced mixed with carbon nanotubes by arc discharge method [see Chem. Phys. Lett. 238(1995) 286]. However, these results have merely confirmed that most of the products were the wire shaped one dimensional carbon nanotubes and a quite small quantity of two dimensional carbon nanotubes was produced.

V. Ivanov et al. reported that the coil shaped carbon nanotubes as well as the wire shaped carbon nanotubes were produced by using the catalyst of loading iron, cobalt or copper on the carbon black or silica support [see Chem. Phys. Lett. 223(1994) 329].

Y. C. Sui et al. prepared anodic aluminum oxide (AAO) template with three dimensional structure and loaded the cobalt catalyst thereto to produce carbon nanotubes with the three dimensional structure [see Carbon 39(2001) 1709].

L. P. Biro et al. found Y-junction carbon nanotubes in carbon nanotubes produced by vaporization at the temperature of 300-450° C. after dispersing C60-fullerene on the stainless steel plate [see Chem. Phys. Lett. 306(1999) 155]. They also reported that a large quantity of Y-junction carbon nanotubes can be produced at the reaction temperature of 800-1000° C. by introducing the catalyst, for example Iron(II) phthalocyanine (FePc), into the reactor [see Physica B 323(2002) 336]. They reported particularly that maximum 30% of Y-junction carbon nanotubes can be produced. However, the foregoing methods for preparing Y-junction or Y-branched carbon nanotubes are merely on the stage of confirming the synthesis itself. Most of the products synthesized by those methods are two dimensional carbon nanotubes with simple structure in which the number of the junction point is only one or at most two to three.

Further, as set forth hereinbefore, in order to use carbon nanotubes as materials for electrodes, reinforcing agents for polymers, transistors or electrochemical products, the Y-branched carbon nanotubes having two or three dimensional structure are much preferable to the linear carbon nanotubes having one dimensional structure. Accordingly, the Y-branched carbon nanotubes having two or three dimensional structure has great potential as materials for nano-scale transistors, amplifiers or electrodes.

Particularly, when used as material for electrodes, Y-branched carbon nanotubes having two or three dimensional tree-like structure are expected remarkably excellent in the efficiency and stability of the electrode because of the junctions either between the carbon nanotubes or between the carbon nanotubes and the current.

Accordingly, it would be of great significance to develop a process for preparing two or three dimensional Y-branched carbon nanotubes or to establish a process for preparing them in bulk.

In this respect, the inventors noticed that the catalysts used for preparing carbon nanotubes can be used to catalyze the decomposition reaction of carbon nanotubes depending on the reaction conditions and found that when the catalyst particles are loaded on the surface of carbon nanotubes and the catalyst-loaded carbon nanotubes are suitably treated, partial damage or destruction of the surface of carbon nanotubes occurs so that the catalyst particles can be bonded more tightly to the carbon nanotubes, and then the growth of new carbon nanotube branches can be initiated by the catalyst from the positions where the catalyst particles are bonded, whereby Y-branched carbon nanotubes can be prepared. In this way, the inventors have completed the invention.

Further the inventors have learned that when the present invention is applied repeatedly to the obtained Y-branched carbon nanotubes, the branches can spread out and, as a result, three dimensional tree-like carbon nanotubes with plural branches can be produced.

### DETAILED DESCRIPTION OF THE INVENTION

[Technical Problem]

An object of the present invention is to provide a process for preparing Y-branched carbon nanotubes, comprising the steps of: (a) loading a catalyst on a carbon nanotube carrier, (b) pre-treating the catalyst-loaded carbon nanotubes to have the catalyst bonded tightly to the surface of carbon nanotubes, and (c) performing a synthetic reaction of carbon nanotubes using the obtained catalyst-loaded carbon nanotubes.

Another object of the present invention is to provide Y-branched carbon nanotubes having one or more Y-junctions, prepared by said process for preparing Y-branched carbon nanotubes.

A further object of the present invention is to provide three dimensional carbon nanotubes having one or more multiple Y-junctions, wherein said Y-junctions are repeated more than twice, and the preparation therefor.

[Technical Solution]

According to one preferred embodiment of the present invention, it provided a process for preparing three dimensional carbon nanotubes with one or more Y-junctions, comprising the step of:

loading a catalyst, for instance catalyst particles or catalyst solution of metals or metal compounds on a carbon nanotube carrier;

pre-treating the catalyst-loaded carbon nanotubes to have the catalyst bonded tightly to the surface of carbon nanotubes; and

performing a synthetic reaction of carbon nanotubes using the obtained catalyst-loaded carbon nanotubes.

Carbon nanotubes applicable as the catalyst carriers in the present invention can be any kind of carbon nanotubes or carbon nanofibers irrespective of their preparation processes. For instance, all the single-wall or multi-wall carbon nanotubes or carbon nanofibers with or without Y-junction structure can be used.

Examples of the methods for loading a catalyst on the surface of carbon nanotubes may include: conventional methods for loading a catalyst on a carrier available in the art such as impregnation, precipitation and sol-gel method; methods for adhering a catalyst on a carrier, for example, such as chemical vapor deposition (CVD), sputtering and evaporation; or methods of using a colloidal solution, for example, such as dispersing or spraying the micelle or reverse micelle of catalyst particles on the surface of carbon nanotubes. However, the present invention is not limited by these methods.

In the impregnation method among the foregoing methods, metal precursors are dissolved in a solution, carbon nanotubes are impregnated in the solution, and then the solvent is evaporated or removed to deposit the catalyst as small particles on the surface of carbon nanotube. The method is used generally for loading a catalyst on a carrier, and the composition of catalyst can be modified easily through the treatment of oxidation, reduction, pre-nitriding or pre-sulfiding after loading. On the other hand, other said methods except impregnation are to deposit the catalyst on the surface of carbon nanotubes under the state wherein the chemical composition or property of catalyst is already determined. Although there is a slight difference from each other methods in terms, these two methods can be used alike as a general method to deposit catalytic metals or metal compounds on the surface of carbon nanotubes.

For the uniformity of terms in the present invention, all the methods capable of depositing a catalytic metal or metal compound thereof on the carbon nanotube carrier are commonly referred to as ‘loading or loading method’. Namely, in the present invention, ‘loading or loading method’ represents any methods capable of depositing a catalyst on the carbon nanotube surface, including: conventional methods for loading a catalyst on the surface of carrier such as impregnation, precipitation and sol-gel method; methods for adhering a catalyst on a carrier, for example, such as chemical vapor deposition, sputtering and evaporation; or methods of using a colloidal solution, for example, such as the method of dispersing or spraying the micelle or reverse micelle of catalyst particles.

Further, for the uniformity of terms in the present invention, the carbon nanotubes of which the catalyst exists on the surface by any of above-mentioned methods are called ‘the catalyst-loaded carbon nanotubes’.

The catalyst applicable to the present invention is not specifically limited. Any catalytic metals generally used for the preparation of carbon nanotubes, for example, transition metals such as iron, cobalt and nickel, noble metals such as platinum and palladium, alkali metals and alkaline earth metals can be used as metal per se, or as a form of metal oxide, metal nitride, metal boride, metal fluoride, metal bromide or metal sulfide, or the mixture thereof.

In the specification of the present invention, the tight bonding of the catalyst to the surface of carbon nanotubes means not only a chemical bonding or insertion caused by decomposition, damage or destruction of the surface of carbon nanotubes, but also implies the state of bonding wherein the catalyst is physically adhered to the carbon nanotube surface so tightly that Y-junctions can be formed where the catalyst is adhered and grow continuously without the separation of the new Y-branches and carbon nanotube carriers.

Such tight bonding can be accomplished by either chemical methods such as oxidation, reduction, hydrogenation, sulfidization and acid treatment using sulfuric acid or nitric acid, or physical methods such as compression, drying, absorption and high temperature treatment.

According to a modification of the present invention, when the bonding between the catalyst and the carbon nanotube carrier is strong enough, pre-treatment may not be required, or the pre-treatment of the catalyst-loaded carbon nanotubes may be performed concurrently with the synthetic reaction of carbon nanotubes. In these cases, the step of loading catalyst or the step of synthesizing carbon nanotubes should be understood to comprise the step of pre-treatment as well. Therefore, this modification can be certainly included within the scope of the present invention.

For the step of synthesizing Y-branched carbon nanotubes with catalyst-loaded carbon nanotubes, any known conventional methods for synthesizing carbon nanotubes, for example, methods of arc discharge, laser ablation, chemical vapor deposition (CVD), catalytic synthesis, plasma synthesis and subsequent gaseous synthesis can be used.

According to a preferred embodiment of the present invention, carbon nanotubes can be synthesized by putting the catalyst-loaded carbon nanotubes in the quartz boat and placing them in the reactor.

According to another modification of the present invention, two dimensional or three dimensional Y-branched carbon nanotubes can be produced continuously by dispersing the catalyst-loaded carbon nanotubes in solvent, introducing it continuously into the reactor and concurrently performing the synthetic reaction of carbon nanotubes.

According to a preferred embodiment of said modification, the catalyst-loaded carbon nanotubes can be prepared in the form of the colloidal solution of aqueous or organic solvent. Said colloidal solution can be finely dispersed or sprayed into the reactor, floated as drops of fine particles in gas, and remain in the form of gaseous colloid for a certain period, whereby two dimensional or three dimensional Y-branched carbon nanotubes can be produced continuously in gas phase.

The methods for making a suspension or colloidal solution prepared by dispersing the catalyst-loaded carbon nanotubes in solvent in gas phase, or the methods for floating it in gas are not particularly restricted. Any conventional method in the pertinent art, for instance, direct spray, siphon spray or atomization is applicable.

On the other hand, in case that the catalyst-loaded carbon nanotubes are dispersed in an organic solvent, a surfactant can be added for the prevention of coagulation of catalyst-loaded carbon nanotubes and for the uniform dispersion of catalyst-loaded carbon nanotubes, in an amount that the synthetic reaction of carbon nanotubes is not affected adversely. The surfactant used may be non-ionic, anionic, cationic or binary ionic and includes any kinds of the surfactant, i.e., carbohydrates, silicones and fluorocarbons. Since the surfactant is used in a small quantity and it can be used as a reactant in the synthetic reaction of carbon nanotubes, it hardly or never affects the reaction adversely. The quantity of the surfactant is not restricted particularly and can be adjusted adequately by the person having ordinary skill in the pertinent art.

The carbon source for synthesizing carbon nanotubes may be, for instance, the organic substance selected from the group consisting of carbon monoxide, C1˜C6 saturated or unsaturated aliphatic carbohydrates and C6˜C10 aromatic carbohydrates. Such carbon sources may have one to three hetero-atoms selected from the group consisting of oxygen, nitrogen, fluorine and sulfur. The carbon source can replace or be partially mixed with the solvent of the colloidal solution.

According to a preferred embodiment of the present invention, the specified gas such as H₂, H₂S, NH₃ can be supplied along with water and the carbon source.

According to another modification of the present invention, tree-shaped Y-branched carbon nanotubes in which Y-junctions are repeatedly generated more than twice can be prepared by applying the present invention to two or three dimensional carbon nanotubes other than one dimensional linear carbon nanotubes.

According to another modification of the present invention, carbon nanotubes having Y-junctions on a plane can be produced by applying the present invention to one dimensional linear carbon nanotubes and further the carbon nanotubes having repeated Y-junctions on a plane can be produced by applying the present invention twice or more.

As the reactor for the synthesis of two or three dimensional Y-branched carbon nanotubes, conventional reactors used for the preparation of carbon nanotubes can be employed without restriction, for example, the reactors used for the methods of thermal heating, chemical vapor deposition (CVD), plasma synthesis, laser ablation, and radio frequency (RF) heating. Reaction procedures for preparing carbon nanotubes or carbon nanofibers are known in the pertinent art. The person skilled in this field can carry out the present invention without difficulty by adequately modifying the parameters of said procedures, e. g., temperature, time, pressure and the like.

On the other hand, in the general synthetic method of carbon nanotubes using catalyst, the shape and property of carbon nanotubes depend on the kind and state of the catalyst. It is possible to selectively synthesize single-wall or multi-wall carbon nanotubes or carbon nanofibers by properly selecting the kind and state of the catalyst. In the present invention, the shape and property of the grown carbon nanotube branches seem to be variable depending on the kind and state of the catalyst and the structure of carbon nanotube branches can be adjusted to single-wall or multi-wall carbon nanotubes or carbon nanofibers by suitably selecting the kind and state of the catalyst.

In conclusion, according to the present invention, it is possible to produce two or three dimensional Y-branched carbon nanotubes or carbon nanofibers in bulk, reproducibly and economically, using the existing conventional facilities and procedures for the preparation of carbon nanotubes or carbon nanofibers.

Furthermore, two or three dimensional Y-branched carbon nanotubes or carbon nanofibers can be synthesized continuously in gas phase by supplying the catalyst-loaded carbon nanotubes, which is already prepared as a colloidal solution.

According to the present invention, Y-branched carbon nanotubes can be employed in electrodes, transistors, electronic materials and structure-reinforced polymers.

The present invention is described more specifically with reference to the following drawing and figures.

### BRIEF DESCRIPTION OF DRAWING

FIG. 1 is the schematic representation explaining the preparation process of two or three dimensional Y-branched carbon nanotubes according to the present invention. In FIG. 1, (a) represents non-catalyst loaded linear carbon nanotubes, (b) represents carbon nanotubes on the surface of which the catalyst particles are loaded, (c) represents the state wherein the catalyst particles loaded on the surface of carbon nanotubes are bonded more tightly or inserted into carbon nanotubes by pre-treatment, and (d) shows Y-branched carbon nanotubes having branches grown at the position where the catalyst is bonded. Although only multi-wall carbon nanotubes are presented in FIG. 1, single-wall carbon nanotubes can be also employed in the present invention.

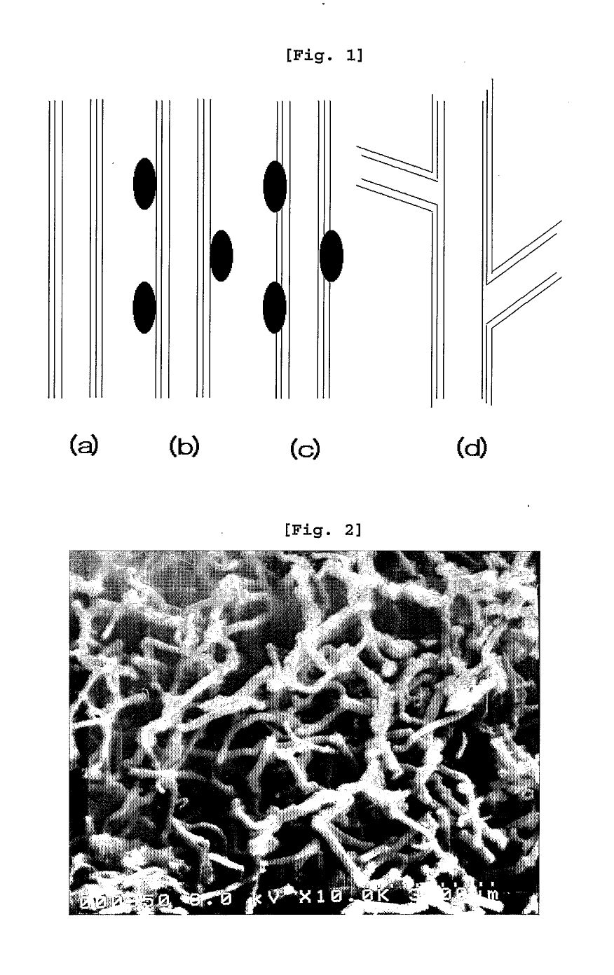

FIG. 2 to FIG. 4 show SEM photographs of Y-branched carbon nanotubes prepared according to the present invention.

### BEST MODE FOR THE INVENTION

The present invention can be understood more readily with reference to the following examples. However, these examples are intended to illustrate the present invention only and are not to be construed to limit the scope of the present invention.

### EXAMPLE 1

(1) Preparation of Catalyst-Loaded One Dimensional Carbon Nanotubes

1.81 g of Fe(NO₃)₃9H₂O was loaded on 10 g of multi-wall carbon nanotubes with 20 m²/g of surface area and 60 nm in diameter [prepared as described in WO03/008331] by impregnation and then dried at 110° C. for 12 hours or longer.

The obtained carbon nanotubes loaded with Fe(NO₃)₃9H₂O were reduced for 3 hours with flowing hydrogen gas at 600° C. During the process of reduction, the carbon nanotubes used as a carrier were partially destructed through hydrogenation as well as reduction of iron particles and the original carbon nanotubes seemed to be bonded chemically to the newly produced carbon nanotubes. The resulted Fe-loaded carbon nanotubes comprised 2.5 wt % of Fe.

(2) Preparation of Y-Branched Carbon Nanotubes

0.2 g of Fe-loaded one dimensional carbon nanotubes prepared in the above step 1 were put in quartz boat to be positioned at the midst of the quartz tube with 27 mm diameter in an electric furnace. The reaction temperature was elevated to 1000° C. with flowing helium gas in the rate of 100 ml/min.

When the reaction temperature was reached to 1000° C., hydrogen gas comprising 2 vol % of vaporized benzene was introduced into the reactor for 30 minutes to produce Y-branched carbon nanotubes.

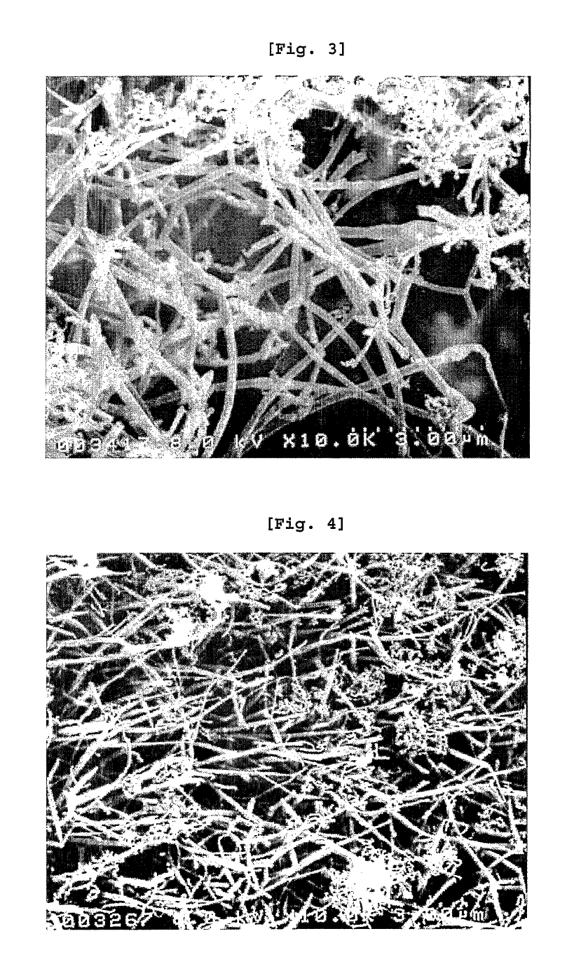

The result of analyzing the obtained product by a scanning electron microscope (SEM) is showing in FIG. 2. As shown in FIG. 2, it was confirmed that the various forms of carbon nanotubes with Y-junctions were produced between the multi-wall carbon nanotubes used.

### EXAMPLE 2

(1) Preparation of Catalyst-Loaded One Dimensional Carbon Nanotubes

Carbon nanotubes loaded with Fe(NO₃)₃9H₂O were produced in the same manner as described in Example 1 except that the reduction was not performed.

(2) Preparation of Y-Branched Carbon Nanotubes

0.2 g of carbon nanotubes loaded with Fe(NO₃)₃9H₂O prepared in the step (1) were put in quartz boat to be positioned at the midst of the quartz tube with 27 mm diameter in an electric furnace. The reaction temperature in the furnace was elevated to 1000° C. with flowing helium gas at a rate of 100 ml/min. Then, nitrate of ferric nitrate was thermally decomposed to oxidize the surface of carbon nanotubes loaded with ferric nitrate particles and destructed some part of the carbon nanotubes. In this way, iron particles were bonded tightly to carbon nanotubes.

When the reaction temperature reached 1000° C., hydrogen gas comprising 2 vol % of vaporized benzene was introduced into the reactor for 30 minutes to produce carbon nanotubes with Y-junctions.

As a result of analyzing the obtained product by a scanning electron microscope (SEM), it was confirmed that the various forms of carbon nanotubes with Y-junctions were produced between the multi-wall carbon nanotubes as in Example 1.

### EXAMPLE 3

(1) Preparation of Catalyst-Loaded One Dimensional Carbon Nanotubes

The temperature was elevated to 450° C. while helium gas was flowed on carbon nanotubes loaded with Fe(NO₃)₃9H₂O, which were produced in the same manner as described in Example 1. When the temperature reached 450° C., the gas mixture of hydrogen and H₂S in the volume ratio of 95:5 was supplied for 2 hours to convert ferric nitrate to be changed to ferrous sulfide (FeS).

(2) Preparation of Y-Branched Carbon Nanotubes

0.2 g of carbon nanotubes loaded with FeS, prepared in the step (1) were put in quartz boat to be positioned at the midst of the quartz tube with 27 mm diameter in an electric furnace. The reaction temperature in the furnace was elevated to 1000° C. with flowing helium gas at a rate of 100 ml/min.

When the reaction temperature was reached to 100° C., hydrogen gas comprising 2 vol % of vaporized benzene was introduced into the reactor for 30 minutes to produce carbon nanotubes with Y-junctions.

The result of analyzing the final product by a scanning electron microscope (SEM) is showing in FIG. 3. As shown in FIG. 3, it was confirmed that the various forms of carbon nanotubes with Y-junctions were produced between the multi-wall carbon nanotubes.

### EXAMPLE 4

The same multi-wall carbon nanotubes (60 nm diameter) as used in Example 1 was put in a sputter [Comtecs Inc., Korea] which was adjusted to the vacuum of about 10⁻⁶ Torr. The pressure was adjusted to 2×10⁻² Torr while argon gas was flowed in, and argon plasma was formed using DC voltage, whereby cobalt was subjected to ‘sputtering’ for 5 minutes to produce about 1 wt % of cobalt loaded carbon nanotubes.

The obtained cobalt-loaded carbon nanotubes were oxidized with flowing nitrogen gas comprising 1% of oxygen for 10 min. at 220° C. By such oxidation, the structure of carbon nanotubes seemed to be damaged partially.

Carbon nanotubes with Y-junctions were synthesized using the cobalt-loaded and oxidized carbon nanotubes in the manner analogous to Example 1.

### EXAMPLE 5

Fe loaded carbon nanotubes prepared in Example 1 was mixed with benzene in the weight ratio of 95:5. The mixture solution was jetted into the vertical type reactor with 25 mm diameter and 1 m length to produce Y-junction carbon nanotube. The reaction temperature was 1000° C. and argon gas was supplied at a flow rate of 500 ml/min. According to Example 5, the mixture solution of Fe loaded carbon nanotubes can be continuously introduced into the reactor. Therefore, carbon nanotubes with Y-junctions can be produced in bulk.

### EXAMPLE 6

In order to disperse Fe loaded carbon nanotubes in benzene more uniformly, nonionic surfactant Tween #20 was added in 10 wt % and the procedures of Example 5 were repeated to produce Y-junction carbon nanotubes in bulk.

The result of analyzing the final product by a scanning electron microscope (SEM) is shown in FIG. 3. As shown in FIG. 3, it was confirmed that the various forms of Y-junction carbon nanotubes were produced between the multi-wall carbon nanotubes.

### EXAMPLE 7

The procedures analogous to Example 1 were repeated with carbon nanotubes prepared in Example 1 to produce carbon nanotubes with the multiple Y-junctions.

### INDUSTRIAL AVAILABILITY

According to the present invention, Y-branched carbon nanotubes having at least one or more Y-junctions in various shapes can be produced easily, simply and in bulk by utilizing the known methods and the conventional facilities under the usual processing condition. Thus, the present invention provides an industrially promising method. Further, Y-branched carbon nanotubes of the present invention hold great potential in regard of the materials for electrodes, reinforcing agents for polymers, transistors and electrochemical products.

1. A process for preparing Y-branched carbon nanotubes comprising the steps of:
(a) loading a catalyst on a carbon nanotube carrier;
(b) pre-treating the catalyst-loaded carbon nanotubes to have the catalyst bonded tightly to the surface of carbon nanotubes; and
(c) performing a synthetic reaction of carbon nanotubes using the obtained catalyst-loaded carbon nanotubes.

2. The process according to claim 1, wherein the carbon nanotube carrier is single-wall or multi-wall carbon nanotubes, or carbon nanofibers with or without Y-branched structure.

3. The process according to claim 1, wherein the catalyst is selected from the group consisting of metals or metal compounds applicable to the preparation of Y-branched carbon nanotubes.

4. The process according to claim 1, wherein the catalyst is used as a form of metal per se, metal oxide, metal nitride, metal boride, metal fluoride, metal bromide, metal sulfide or the mixture thereof.

5. The process according to claim 1, wherein the catalyst is metal complex or metal alloy comprising at least one or more metals.

6. The process according to claim 1, wherein the step of loading a catalyst is carried out by impregnation or precipitation, sol-gel method, chemical vapor deposition, sputtering, evaporation, dispersing method or spraying method.

7. The process according to claim 1, wherein the tight bonding between the catalyst and the surface of carbon nanotubes is accomplished by a chemical pre-treatment selected from the group consisting of oxidation, reduction, hydrogenation, sulfidization and acid treatment, or a physical pre-treatment selected from the group consisting of compression, drying, absorption and high temperature treatment.

8. The process according to claim 1, wherein the tight bonding between the catalyst and the surface of carbon nanotubes is caused by decomposition, damage or destruction of the surface of carbon nanotubes.

9. The process according to claim 1, wherein the synthetic reaction is performed by using a suspension in which the catalyst-loaded carbon nanotubes are dispersed in solvent.

10. The process according to claim 1, The process according to claim 9, wherein the suspension additionally comprised a surfactant.

11. The process according to claim 10, wherein the surfactant is selected from the group consisting of non-ionic, anionic, cationic, binary ionic surfactants, and carbohydrates, silicones and fluorocarbons.

12. The process according to claim 1, wherein the synthetic reaction is performed by a method selected from the group consisting of thermal heating, chemical vapor deposition, plasma method, laser ablation, and radio frequency heating.

13. Y-branched carbon nanotubes prepared by the process according to claim 1 characterized by having at least one or more Y-junctions.

14. Y-branched carbon nanotubes prepared by the process according to claim 1 characterized by having multiple Y-junctions repeated twice or more.

15. A product selected from the group consisting of electrode, transistor, material for electronic product and structure reinforced polymer having the Y-branched carbon nanotubes according to claim 13.

16. A product selected from the group consisting of electrode, transistor, material for electronic product and structure reinforced polymer having the Y-branched carbon nanotubes according to claim 14.

17. The process according to claim 2, wherein the tight bonding between the catalyst and the surface of carbon nanotubes is accomplished by a chemical pre-treatment selected from the group consisting of oxidation, reduction, hydrogenation, sulfidization and acid treatment, or a physical pre-treatment selected from the group consisting of compression, drying, absorption and high temperature treatment.

18. The process according to claim 2, wherein the tight bonding between the catalyst and the surface of carbon nanotubes is caused by decomposition, damage or destruction of the surface of carbon nanotubes.

19. The process according to claim 2, wherein the synthetic reaction is performed by using a suspension in which the catalyst-loaded carbon nanotubes are dispersed in solvent.

20. The process according to claim 3, wherein the synthetic reaction is performed by using a suspension in which the catalyst-loaded carbon nanotubes are dispersed in solvent.
